(19) United States
(12) Patent Application Publication
(10) Pub. No.: US 2026/0001012 A1
(43) Pub. Date: Jan. 1, 2026

(54) FILTERING MACHINE OF FILTER PLATE TYPE

(71) Applicant: MITSUBISHI KAKOKI KAISHA, LTD., Kanagawa (JP)

(72) Inventor: Takuya SUGIUCHI, Kanagawa (JP)

(73) Assignee: MITSUBISHI KAKOKI KAISHA, LTD., Kanagawa (JP)

(21) Appl. No.: 19/108,076

(22) PCT Filed: Jul. 28, 2023
(86) PCT No.: PCT/JP2023/027769

§ 371 Date: Feb. 28, 2025

(30) Foreign Application Priority Data
Aug. 30, 2022 (JP) 2022-136981

(51) Int. Cl. B01D 25/127; B01D 25/00

(52) U.S. Cl. CPC B01D 25/127; B01D 25/007

(57) ABSTRACT

To provide a highly convenient filter-plate-type filtration device capable of more effectively preventing leakage of a raw liquid to be filtrated and filtrate through a filter material. The filter-plate-type filtration device includes: a plurality of filter plates arranged with a filter material sandwiched therebetween; a filtration chamber formed between the plurality of filter plates; a raw liquid introduction path configured to introduce a raw liquid to be filtrated into the filtration chamber; a pressure sealing unit configured to apply a sealing pressure to the filter material such that leakage of the raw liquid to be filtrated and the filtrate from inside of the filtration chamber to outside of the filtration chamber is prevented; and a control unit configured to automatically control the sealing pressure in response to fluctuations in a pressure in the filtration chamber.

### TECHNICAL FIELD

The present invention relates to a filter-plate-type filtration device in which a raw liquid to be filtrated (hereinafter, referred to as “raw liquid”) and a filtrate are prevented from leaking.

### BACKGROUND ART

In the related art, there is a filter-plate-type filtration device that performs filtration inside a filtration chamber, the filtration chamber being formed by pressing a plurality of filter plates that are freely opened and closed against each other closely with a filter material sandwiched therebetween (for example, refer to Patent Literature 1).

A multi-stage horizontal filter-plate-type filtration device or the like having the above configuration can automatically repeat a filtration process, and is also called a Schneider type.

Further, there is an invention of a pressure filter that pressurizes and filters a concentrate with pressure of compressed air in a filter chamber formed by bringing a lower surface of an upper filter frame into close contact with an upper surface of a frame of a lower filter plate via a filter cloth (for example, refer to Patent Literature 2).

### CITATION LIST

### Patent Literature

Patent Literature 1: JP2012-24712A

Patent Literature 2: JP2696666B

### SUMMARY OF INVENTION

### Technical Problem

In the filter-plate-type filtration device described above, the plurality of filter plates are pressed against each other closely with the filter material sandwiched therebetween to form the filtration chamber. Therefore, due to the structure, a gap that leads from inside the filtration chamber to outside the filtration chamber may occur at a contact surface between the filter material and the filter plate.

In this case, the raw liquid supplied to the filtration chamber may leak through the gap described above to the outside of the filtration chamber due to the supplied pressure.

In addition, the filtrate passing through the filter material may leak from inside the filtration chamber to outside the filtration chamber through the inside of the filter material due to capillary action occurring in the filter material.

In order to prevent such a situation, for example, Patent Literature 2 discloses a mode in which a pair of packings are fixed to and sealed at facing portions of the filter plate and the filter frame that are in contact with each other with the filter cloth sandwiched therebetween.

However, in actual filtration of a filter plate type, the pressure inside the filtration chamber constantly fluctuates, making it difficult to adequately prevent leakage of the raw liquid and the filtrate from the filtration chamber using a sealing method in the related art such as packing.

The present invention has been made in view of the above problems, and an object of the present invention is to provide a highly convenient filter-plate-type filtration device capable of more effectively preventing leakage of a raw liquid and filtrate from a filtration chamber.

### Solution to Problem

In order to solve the above problems, the present invention provides a filter-plate-type filtration device that performs filtration inside a filtration chamber, the filtration chamber being formed by pressing a plurality of filter plates that are freely opened and closed against each other closely with a filter material sandwiched therebetween. The filter-plate-type filtration device includes: a plurality of filter plates arranged to sandwich the filter material; a filtration chamber formed between the filter plates; a raw liquid introduction path configured to allow a raw liquid containing a solid matter to be filtrated to be introduced to the filtration chamber; a pressure sealing unit configured to apply a sealing pressure to the filter material to prevent the raw liquid and a filtrate in the filtration chamber from leaking to outside of the filtration chamber; and a control unit configured to automatically control the sealing pressure in response to fluctuations in a filtration chamber pressure.

In a preferred embodiment of the present invention, the pressure sealing unit is configured to apply the sealing pressure to the filter material by supplying a sealing fluid to the filter material.

In a preferred embodiment of the present invention, the pressure sealing unit is configured to apply the sealing pressure to the filter material by supplying the sealing fluid to the filter material from a plurality of different directions.

In a preferred embodiment of the present invention, the pressure sealing unit has a pressure seal portion main body formed of an elastic body, and the pressure sealing unit is configured to apply the sealing pressure to the filter material by supplying a sealing fluid to deform the pressure seal portion main body.

In a preferred embodiment of the present invention, the control unit is configured to automatically control the sealing pressure such that leakage of the raw liquid to be filtrated and the filtrate to the outside of the filtration chamber is prevented.

In a preferred embodiment of the present invention, the control unit is configured to automatically control the sealing pressure such that the sealing fluid supplied to the filter material is prevented from entering the filtration chamber.

In a preferred embodiment of the present invention, the control unit is configured to control the sealing pressure such that a differential pressure between the filtration chamber pressure and the sealing pressure is maintained at a predetermined differential pressure value.

In a preferred embodiment of the present invention, the pressure sealing unit includes a first pressure sensing unit configured to sense a first pressure in the raw liquid introduction path, and the control unit is configured to control the sealing pressure based on a filtration chamber pressure estimated from the first pressure in the raw liquid introduction path.

In a preferred embodiment of the present invention, the pressure sealing unit includes a fluid supply path configured to supply a sealing fluid to the filter material, and a second pressure sensing unit configured to sense a second pressure in the fluid supply path, and the control unit is configured to control the sealing pressure based on the filtration chamber pressure estimated from the first pressure in the raw liquid introduction path sensed by the first pressure sensing unit and the second pressure in the fluid supply path sensed by the second pressure sensing unit.

In a preferred embodiment of the present invention, a plurality of the filtration chambers are provided, the raw liquid introduction path has branch introduction paths configured to allow the raw liquid to be introduced to the plurality of filtration chambers, respectively, the first pressure sensing unit is configured to sense a first pressure in the raw liquid introduction path upstream of a branch point of the branch introduction paths, and the control unit is configured to control the sealing pressure based on a filtration chamber pressure estimated based on the first pressure in the raw liquid introduction path.

In a preferred embodiment of the present invention, the pressure sealing unit includes a fluid supply path configured to supply a sealing fluid to the filter material, and a second pressure sensing unit configured to sense a second pressure in the fluid supply path, the fluid supply path includes branch supply paths configured to supply the sealing fluid to a plurality of the filter material disposed in the plurality of filtration chambers respectively, the second pressure sensing unit is configured to sense a pressure in the fluid supply path upstream of a branch point of the branch supply paths, and the control unit is configured to control the sealing pressure based on the first pressure in the raw liquid introduction path and the second pressure in the fluid supply path.

In a preferred embodiment of the present invention, the control unit is configured to control the sealing pressure such that a differential pressure between the first pressure in the raw liquid introduction path and the second pressure in the fluid supply path is maintained at a predetermined differential pressure value.

The present invention further provided a filtration method performed by using a filter-plate-type filtration device including a plurality of filter plates arranged with a filter material sandwiched therebetween and a filtration chamber formed between the filter plates.

The filtration method includes: a pressure sealing step of applying a sealing pressure to the filter material; and a pressure control step of automatically controlling the sealing pressure such that a raw liquid containing a solid matter to be filtrated introduced into the filtration chamber and a filtrate are prevented from leaking to outside of the filtration chamber.

In a preferred embodiment of the present invention, in the pressure sealing step, the sealing pressure is supplied to the filter material by supplying a sealing fluid to the filter material.

In a preferred embodiment of the present invention, in the pressure sealing step, the sealing pressure is supplied to the filter material by supplying the sealing fluid to the filter material from a plurality of different directions.

In a preferred embodiment of the present invention, in the pressure sealing step, the sealing pressure is supplied to the filter material by supplying a sealing fluid to deform an elastic body.

In a preferred embodiment of the present invention, in the pressure control step, the sealing pressure is automatically controlled such that leakage of the raw liquid and the filtrate to the outside of the filtration chamber is prevented.

In a preferred embodiment of the present invention, in the pressure control step, the sealing pressure is automatically controlled such that the sealing fluid supplied to the filter material is prevented from entering the filtration chamber.

### Advantageous Effects of Invention

According to the present invention, it is possible to provide a highly convenient filter-plate-type filtration device capable of more effectively preventing leakage of a raw liquid and filtrate from a filtration chamber.

### BRIEF DESCRIPTION OF DRAWINGS

FIG. 1 is a view showing a filter-plate-type filtration device according to an embodiment of the present invention.

FIG. 2 is a view showing flows of fluids and pressure inside the filter-plate-type filtration device according to the embodiment of the present invention.

FIG. 3 is a cross-sectional view taken along line A-A′ of the filter-plate-type filtration device according to the embodiment of the present invention.

FIG. 4 is a cross-sectional view taken along line A-A′ of a filter-plate-type filtration device according to another embodiment of the present invention.

FIG. 5 is a cross-sectional view of a filter-plate-type filtration device according to another embodiment of the present invention.

FIG. 6 is a cross-sectional view of a filter-plate-type filtration device according to another embodiment of the present invention.

FIG. 7 is a view showing flows of fluids and pressure inside the filter-plate-type filtration device according to the other embodiment of the present invention.

FIGS. 8A and 8B are cross-sectional views of a filter-plate-type filtration device according to another embodiment of the present invention.

FIG. 9 is a perspective view showing an example of an overall configuration of a horizontal filter-plate-type filtration device.

FIG. 10 is a cross-sectional view taken along line A-A′ of a filter-plate-type filtration device according to another embodiment of the present invention.

FIG. 11 is a cross-sectional view taken along line A-A′ of a filter-plate-type filtration device according to another embodiment of the present invention.

### DESCRIPTION OF EMBODIMENTS

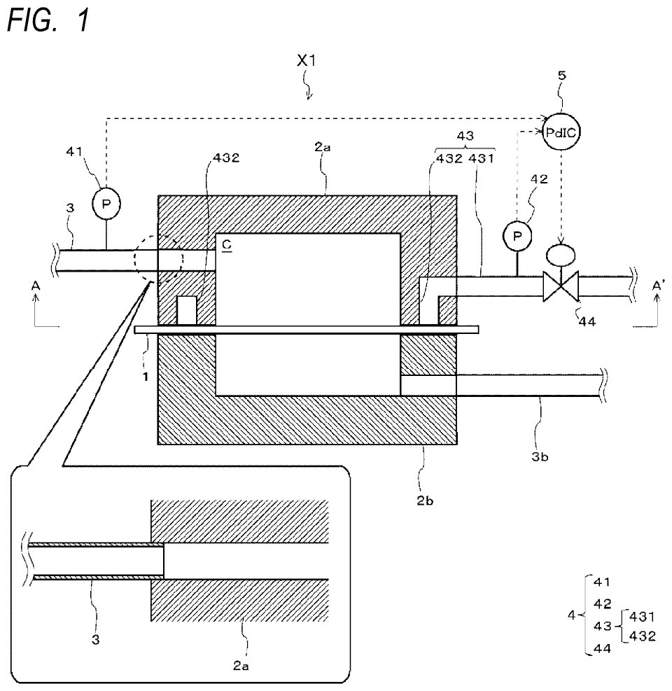

Hereinafter, a filter-plate-type filtration device according to an embodiment of the present invention will be described with reference to FIGS. 1 to 9.

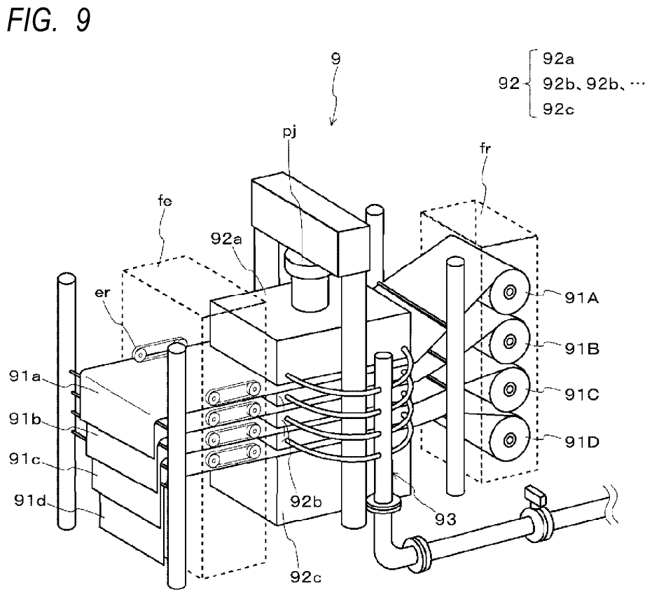

FIG. 9 is a perspective view showing an example of an overall configuration of a horizontal filter-plate-type filtration device.

A horizontal filter-plate-type filtration device 9 shown in FIG. 9 includes an upper filter plate 92a, a plurality of intermediate filter plates 92b, 92b, 92b, and a lower filter plate 92c. The upper filter plate 92a, the plurality of intermediate filter plates 92b, 92b, 92b, and the lower filter plate 92c are stacked in an upper-lower direction with a guide rod (not shown) inserted therethrough to guide a vertical movement.

A hollow filter chamber (filtration chamber) (not shown) is formed between the upper filter plate 92a and the intermediate filter plate 92b, between the intermediate filter plate 92b and the intermediate filter plate 92b, and between the intermediate filter plate 92b and the lower filter plate 92c.

The upper filter plate 92a has a function of receiving a raw liquid containing a solid matter to be filtrated, the lower filter plate 92c has a function of collecting a liquid after filtration (filtrate), and the intermediate filter plates 92b, 92b, 92b have both functions. The upper filter plate, the plurality of intermediate filter plates, and the lower filter plate are collectively referred to as a filter plate stack 92.

Further, a filter material rack fr is disposed in a space adjacent to the filter plate stack 92, and a plurality of filter material rollers 91A, 91B, 91C, 91D are disposed in a freely rotatable manner.

The filter material rollers 91A, 91B, 91C, 91D each have a filter material 91a, 91b, 91c, 91d wound in a roll shape, respectively, and serve as a supply device that supplies the filter material 91a, 91b, 91c, 91d from one side to the other side on an upper surface of respective filter plates (the intermediate filter plates 92b, 92b, 92b, and the lower filter plate 92c).

Further, a filter material extractor fe is disposed in a space adjacent to the filter plate stack 92.

At the time of replacing the filter material, the filter materials 91a, 91b, 91c, and 91d are drawn out from the upper surface of the respective filter plates (the intermediate filter plates 92b, 92b, 92b, the lower filter plate 92c) by a discharge roll device er, and are discharged to the outside of the device.

An operation of the horizontal filter-plate-type filtration device 9 will be described below.

First, the stacked filter plates (the upper filter plate 92a, the intermediate filter plates 92b, 92b, 92b, and the lower filter plate 92c) are pressed by an upper pressure jack pj to bring the filtration chambers into a sealed state. The raw liquid is supplied onto the filter materials 91a, 91b, 91c, and 91d in each of the filtration chambers in the sealed state through a raw liquid introduction path 93, and a filtration process is started.

As the filtration process progresses, the filtration resistance of the filter materials 91a, 91b, 91c, and 91d gradually increases, making the filtration difficult. Then, the supply of the raw liquid is stopped and the pressurized state by the pressure jack pj is released.

Then, the upper filter plate 92a and the plurality of intermediate filter plates 92b, 92b, and 92b are pulled upward, gaps are created between the upper filter plate 92a and the intermediate filter plate 92b, between the intermediate filter plate 92b and the intermediate filter plate 92b, and between the intermediate filter plate 92b and the lower filter plate 92c, and a tightened state of the filter materials 91a, 91b, 91c, and 91d is released.

At this time, by moving the filter materials 91a, 91b, 91c, and 91d that have been released from the tightened state, the filter material extractor fe replaces used portions of the filter materials 91a, 91b, 91c, and 91d disposed between the upper filter plate 92a and the intermediate filter plate 92b, between the intermediate filter plate 92b and the intermediate filter plate 92b, and between the intermediate filter plate 92b and the lower filter plate 92c with unused portion.

For the purpose of reducing an installation area of the horizontal filter-plate-type filtration device 9, a filtration area per stage is set to an appropriate size, and multiple stages are provided to increase an overall filtration area and achieve a required filtration capacity, but the basic structure and effects are the same for a single stage.

### First Embodiment

FIG. 1 is a cross-sectional view showing a structure of a filter-plate-type filtration device X1 according to an embodiment of the present invention. As shown in FIG. 1, the filter-plate-type filtration device X1 includes a filter material 1, a plurality of filter plates (upper filter plate 2a and lower filter plate 2b), a filtration chamber C, a raw liquid introduction path 3, a pressure sealing unit 4, and a control unit 5. The filtration chamber C is formed by assembling the upper filter plate 2a and the lower filter plate 2b with the filter material 1 sandwiched therebetween.

The filter material 1 is sandwiched between the plurality of filter plates (the upper filter plate 2a and the lower filter plate 2b) in such a manner that the inside and outside of the filtration chamber C communicate with each other.

The upper filter plate 2a and the lower filter plate 2b sandwich the filter material 1 from above and below to form the filtration chamber C.

The raw liquid introduction path 3 communicates with the inside of the filtration chamber C from the upper filter plate 2a. The piping of the raw liquid introduction path 3 and the upper filter plate 2a are connected as shown in an enlarged view of FIG. 1. The same applies to the connection between other pipes and the filter plate.

The pressure sealing unit 4 includes a first pressure sensing unit 41, a second pressure sensing unit 42, a fluid supply path 43, and a pressure adjusting unit 44.

The first pressure sensing unit 41 is preferably a pressure sensor or the like, and is provided in the raw liquid introduction path 3 so as to sense a first pressure P1 within the raw liquid introduction path 3 as described later.

The second pressure sensing unit 42 is preferably a pressure sensor or the like, and is provided in the fluid supply path 43 so as to sense a second pressure P2 within a supply path main body 431 (described later) of the fluid supply path 43 as described later.

The fluid supply path 43 includes the supply path main body 431 and a seal flow path (pressing path) 432.

The seal flow path (pressing path) 432 is formed to surround the filtration chamber C (details will be described later).

The pressure adjusting unit 44 is preferably a regulator valve or the like that adjusts a flow rate of a fluid flowing into the fluid supply path 43, and is capable of adjusting the second pressure P2 in the fluid supply path 43 as described below.

The control unit 5 is connected to the first pressure sensing unit 41, the second pressure sensing unit 42, and the pressure adjusting unit 44 at least by wired or wireless signal transmission method. The control unit 5 receives a pressure sensing signal from the first pressure sensing unit 41 and the second pressure sensing unit 42, and based on the signal, sends a signal to the pressure adjusting unit 44 to automatically control the pressure adjusting unit 44.

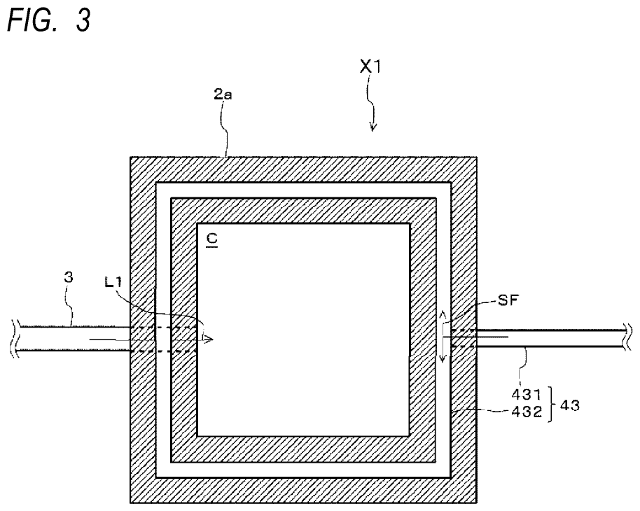

FIG. 3 is a cross-sectional view taken along line A-A′ of the filter-plate-type filtration device X1 shown in FIG. 1. As shown in FIG. 1, the seal flow path (pressing path) 432 is formed on a lower surface of the upper filter plate 2a so as to be in contact with the filter material 1 when the plurality of filter plates (the upper filter plate 2a and the lower filter plate 2b) sandwich the filter material 1, and is formed to surround a periphery of the filtration chamber C as shown in FIG. 3.

That is, a sealing fluid supplied through the supply path main body 431 is adapted to flow through the seal flow path (pressing path) 432 of the fluid supply path 43 to a portion of the filter material 1 located on an outer periphery of the filtration chamber C, so that a sealing pressure is applied to that portion of the filter material 1.

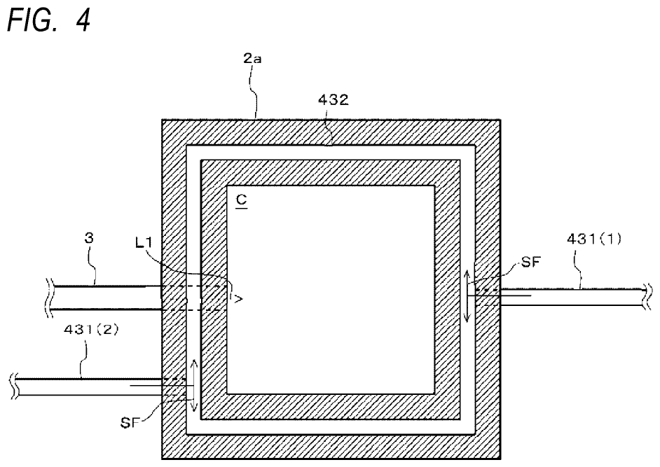

Although one supply path main body 431 is shown in FIG. 3, the present invention is not limited thereto. As shown in FIG. 4, in order to distribute a sealing fluid SF more evenly within the seal flow path (pressing path) 432, an additional second supply path main body 431(2) may be provided in a direction different from that of a first supply path main body 431(1). That is, the pressure sealing unit 4 can apply the sealing pressure to the filter material evenly by supplying the sealing fluid SF to the filter material from a plurality of different directions.

The additional supply path main body 431 may be one or more (two or more).

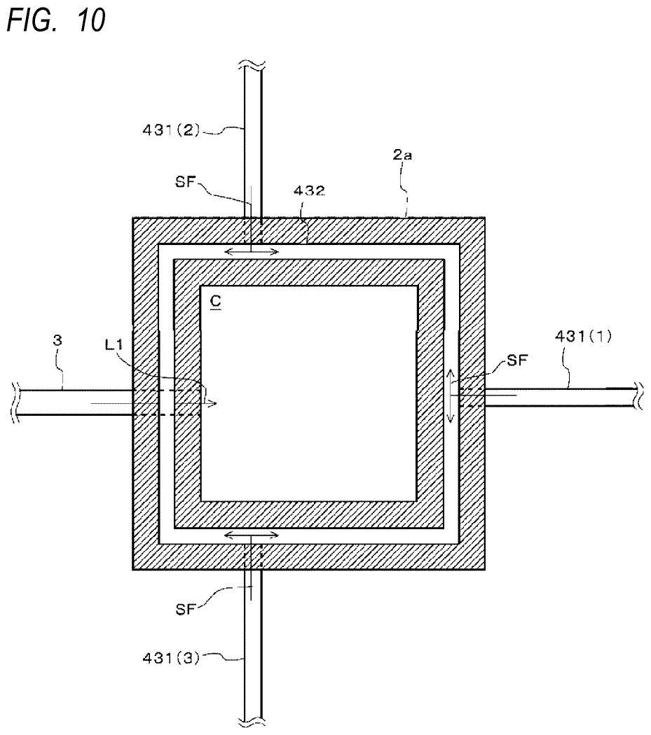

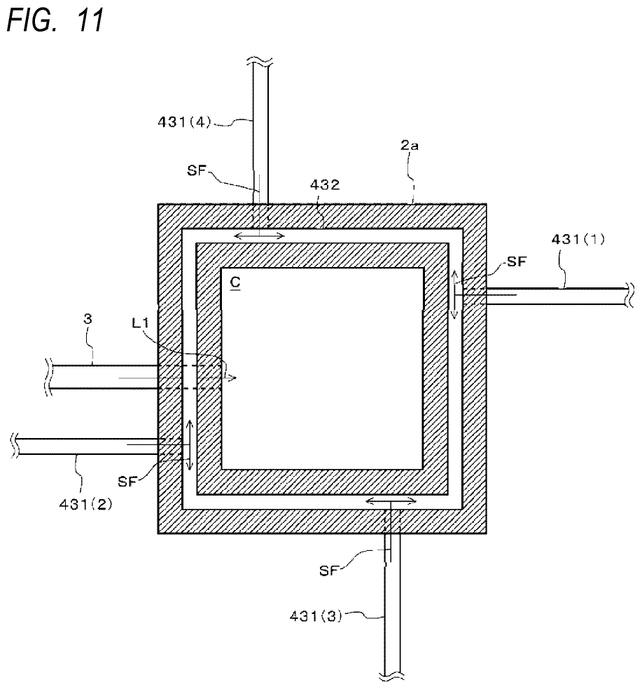

For example, besides the embodiment shown in FIG. 4 in which one additional supply path main body 431 is provided, embodiments shown in FIGS. 10 and 11 in which two or three additional supply path main bodies 431 are provided may also be used.

In this case, it is preferable that the plurality of supply path main bodies 431 are provided at equal intervals along an outer periphery of the seal flow path (pressing path) 432 to uniformly supply the sealing fluid SF.

Hereinafter, it should be noted here that in the first to fourth embodiments described in the present specification, unless otherwise specified, the upper filter plate 2a, the intermediate filter plates 2b-1, 2b-2, and 2b-3 are provided with the fluid supply path 43 (in the case of the intermediate filter plates 2b-1, 2b-2, and 2b-3, branch supply paths 431a, 431b, 431c, and 431d) similar to the above.

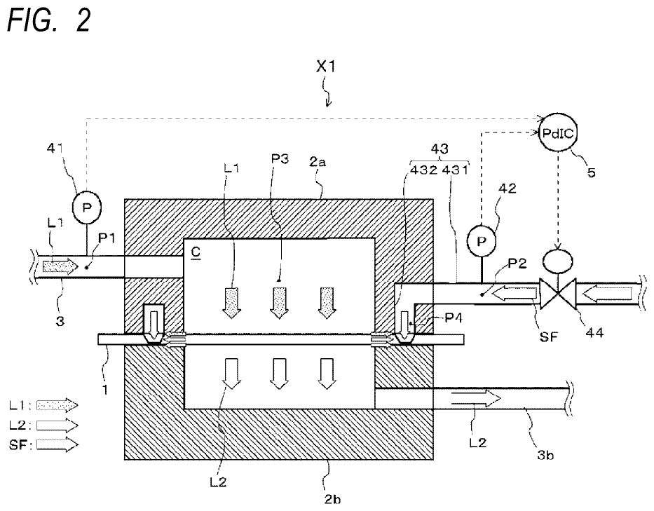

FIG. 2 is a cross-sectional view showing flows of fluids in the filter-plate-type filtration device X1 according to the embodiment of the present invention.

The raw liquid is L1, the filtrate is L2, and the sealing fluid is SF, and the flow of each fluid is indicated by the corresponding arrows.

As shown in FIG. 2, the raw liquid L1 is introduced into the filtration chamber C through the raw liquid introduction path 3 and subjected to filtration by passing through the filter material 1.

The filtrate L2 obtained by the filtration is discharged to the outside of the filtration chamber C through a discharge path 3b.

The sealing fluid SF is a fluid supplied to the seal flow path (pressing path) 432 through the supply path main body 431. By supplying the sealing fluid SF to the seal flow path (pressing path) 432, a sealing portion of the filter material 1 is crushed, and a small gap (a leakage path for the raw liquid L1) generated on a surface where the filter material 1 and the upper filter plate 2a are in contact with each other, the inside of the filter material 1 (a leakage path for the filtrate L2), and a small gap (a leakage path for the filtrate L2) generated on a surface where the filter material 1 and the lower filter plate 2b are in contact with each other are blocked, so that leakage of the raw liquid L1 and the filtrate L2 is prevented.

As the sealing fluid SF, for example, nitrogen is preferably used, and compressed air or other inert gases may also be used. A supply source of the sealing fluid SF may be, for example, a sealing gas supply unit such as a gas cylinder.

Due to the flow of each fluid described above, pressure is applied to the inside of each of the raw liquid introduction path 3, the supply path main body 431, the filtration chamber C, and the seal flow path (pressing path) 432. In the present specification, a pressure applied to the inside of the raw liquid introduction path 3 is defined as the first pressure P1, a pressure applied to the inside of the supply path main body 431 is defined as the second pressure P2, a pressure applied to the inside of the filtration chamber C is defined as a filtration chamber pressure P3, and a pressure applied to the inside of the seal flow path (pressing path) 432 is defined as a sealing pressure P4.

An object of the present invention is to prevent leakage of the raw liquid and the filtrate from the inside of the filtration chamber C by balancing the filtration chamber pressure P3 and the sealing pressure P4.

Therefore, it is ideal to directly measure the filtration chamber pressure P3 and the sealing pressure P4, but it is difficult to measure the filtration chamber pressure P3 and the sealing pressure P4 due to the positions. For this reason, the first pressure P1 and the second pressure P2, which are relatively easily to measure, are measured, and a relationship between the filtration chamber pressure P3 and the sealing pressure P4 is estimated based on the first pressure P1 and the second pressure P2.

Specifically, the control unit 5 estimates the filtration chamber pressure P3 of the filtration chamber C based on the first pressure P1 sensed by the first pressure sensing unit 41.

Here, “estimation” includes regarding the sensed first pressure P1 as the filtration chamber pressure P3 of the filtration chamber C as it is, and calculating the filtration chamber pressure P3 of the filtration chamber C by performing a predetermined arithmetic processing on the sensed first pressure P1.

Subsequently, the control unit 5 automatically operates the pressure adjusting unit 44 based on the estimated filtration chamber pressure P3 of the filtration chamber C and the second pressure P2 in the fluid supply path 43 sensed by the second pressure sensing unit 42. The second pressure P2 may be regarded as the same value as the sealing pressure P4 in terms of the structure of the present embodiment, or the sealing pressure P4 may also be calculated by performing a predetermined arithmetic processing on the second pressure P2.

The control unit 5 constantly monitors the second pressure P2 via the second pressure sensing unit 42, and constantly adjusts an operation amount of the pressure adjusting unit 44 so that a differential pressure between the filtration chamber pressure P3 and the second pressure P2 becomes a predetermined differential pressure value.

As a result, the balance between the filtration chamber pressure P3 estimated from the first pressure P1 in the raw liquid introduction path 3 and the sealing pressure P4 estimated from the second pressure P2 in the fluid supply path 43 is automatically adjusted. According to this adjustment, it is possible to more effectively prevent the leakage of the raw liquid L1 through the gap generated in a contact surface between the filter material 1 and the upper filter plate 2a and the leakage of the filtrate L2 through the inside of the filter material 1 due to the capillary action.

The control unit 5 may be in any form, such as a control panel for industrial equipment or a computer device, as long as it is capable of implementing the functions described above.

### Second Embodiment

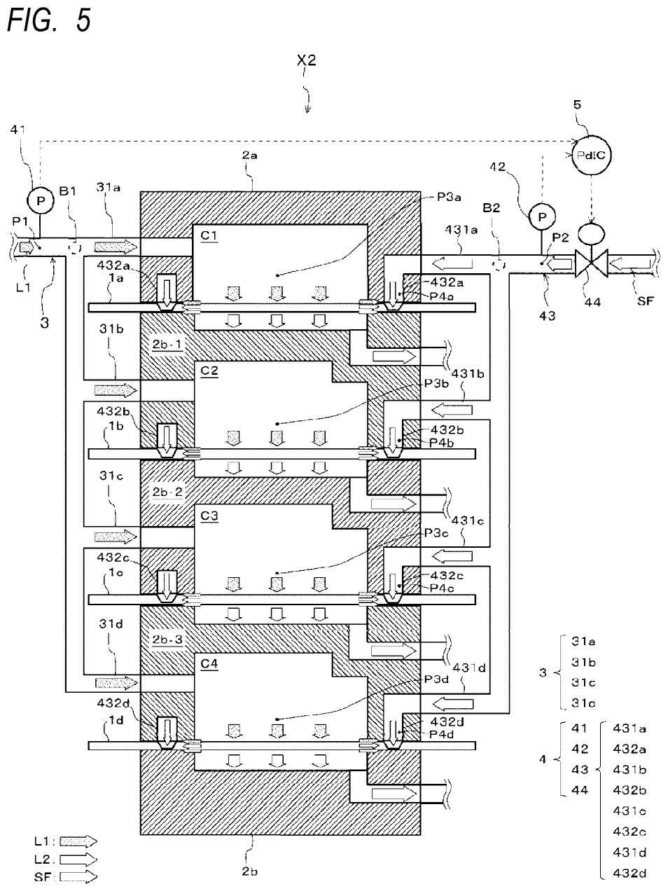

FIG. 5 is a cross-sectional view of a filter-plate-type filtration device X2 according to another embodiment of the present invention.

As shown in FIG. 5, the filter-plate-type filtration device X2 includes a plurality of filter materials 1a, 1b, 1c, and 1d, a plurality of filter plates (the upper filter plate 2a, the intermediate filter plates 2b-1, 2b-2, and 2b-3, the lower filter plate 2b), a plurality of filtration chambers C1, C2, C3 and C4, the raw liquid introduction path 3, the pressure sealing unit 4, and the control unit 5. Hereinafter, the description overlapping with the description of the filter-plate-type filtration device X1 will be appropriately omitted, and only the characteristics of the filter-plate-type filtration device X2 will be described.

The raw liquid introduction path 3 has branch introduction paths 31a, 31b, 31c, and 31d leading from the upper filter plate 2a and the intermediate filter plates 2b-1, 2b-2, and 2b-3 to the respective filtration chambers C1, C2, C3, and C4, and allows the raw liquid L1 to be introduced into each of the filtration chambers C1, C2, C3, C4.

In the present specification, pressures applied to the respective filtration chambers C1, C2, C3, and C4 by the raw liquid L1 are defined as filtration chamber pressures P3a, P3b, P3c, and P3d, respectively.

The fluid supply path 43 includes the branch supply paths 431a, 431b, 431c, and 431d and seal flow paths (pressing paths) 432a, 432b, 432c, and 432d leading from the upper filter plate 2a and the intermediate filter plates 2b-1, 2b-2, and 2b-3 to the respective filtration chambers C1, C2, C3, and C4.

In the present specification, the pressures applied by the sealing fluid SF to the seal flow paths (pressing paths) 432a, 432b, 432c, and 432d are defined as sealing pressures P4a, P4b, P4c, and P4d, respectively.

By supplying the sealing fluid SF to each of the seal flow paths (pressing paths) 432a, 432b, 432c, and 432d through the branch supply paths 431a, 431b, 431c, and 431d, sealing portions of the plurality of filter materials 1a, 1b, 1c, and 1d are crushed by the sealing pressures P4a, P4b, P4c, and P4d, and the leakage path for the raw liquid L1 and the leakage path for the filtrate L2 are blocked, so that leakage of the raw liquid and the filtrate is prevented.

The first pressure sensing unit 41 is preferably a pressure sensor or the like, and is capable of sensing the first pressure P1 in the raw liquid introduction path 3 upstream of a branch point B1 of the branch introduction paths 31a, 31b, 31c and 31d, and transmitting a pressure sensing signal to the control unit 5.

The second pressure sensing unit 42 is preferably a pressure sensor or the like, and is capable of sensing the second pressure P2 in the fluid supply path 43 upstream of a branch point B2 of the branch supply paths 431a, 431b, 431c and 431d, and transmitting a pressure sensing signal to the control unit 5.

The control unit 5 controls the sealing pressures P4a, P4b, P4c and P4d based on the first pressure P1 in the raw liquid introduction path 3 sensed by the first pressure sensing unit 41 and the second pressure P2 in the fluid supply path 43 sensed by the second pressure sensing unit 42.

Here, in terms of the structure of the present embodiment, the first pressure P1 in the raw liquid introduction path 3 sensed by the first pressure sensing unit 41 can be estimated as the filtration chamber pressures P3a, P3b, P3c, and P3d of the plurality of filtration chambers C1, C2, C3, and C4, and the second pressure P2 in the fluid supply path 43 sensed by the second pressure sensing unit 42 can be estimated as the internal pressure (that is, the sealing pressures P4a, P4b, P4c, and P4d) of each of the plurality of branch supply paths 431a, 431b, 431c, and 431d.

Therefore, controlling the sealing pressures P4a, P4b, P4c, and P4d based on the first pressure P1 in the raw liquid introduction path 3 sensed by the first pressure sensing unit 41 and the second pressure P2 in the fluid supply path 43 sensed by the second pressure sensing unit 42 means controlling the sealing pressures P4a, P4b, P4c, and P4d based on the filtration chamber pressures P3a, P3b, P3c, and P3d and the sealing pressures P4a, P4b, P4c, and P4d. As a result, leakage of the filtrate through the filter material 1 caused by the capillary action that may occur in each filtration chamber and oversupply of the sealing fluid can be minimized in the entire filter.

In addition, by maintaining the differential pressure between the first pressure P1 in the raw liquid introduction path 3 sensed by the first pressure sensing unit 41 and the second pressure P2 in the fluid supply path 43 sensed by the second pressure sensing unit 42 at a predetermined differential pressure value, it is possible to perform more robust control to minimize the leakage of the filtrate through the filter material 1 caused by the capillary action that may occur in each filtration chamber and the oversupply of the sealing fluid.

Therefore, the first pressure sensing unit 41 senses the first pressure P1 in the raw liquid introduction path 3 upstream of the branch point B1, and the second pressure sensing unit 42 senses the second pressure P2 in the fluid supply path 43 upstream of the branch point B2, so that there is no need to provide a sensor for each of the filtration chambers C1, C2, C3, and C4 and each of the branch supply paths 431a, 431b, 431c, and 431d, and the leakage of the raw liquid and filtrate and oversupply of the sealing fluid can be minimized in terms of the structure at each portion.

### Third Embodiment

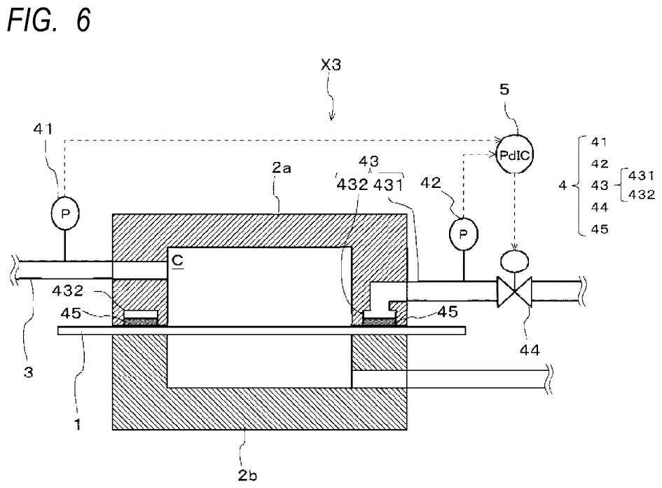

FIG. 6 is a cross-sectional view of a filter-plate-type filtration device X3 according to another embodiment of the present invention.

As shown in FIG. 6, the filter-plate-type filtration device X3 includes the filter material 1, the plurality of filter plates (upper filter plate 2a and lower filter plate 2b), the filtration chamber C, the raw liquid introduction path 3, the pressure sealing unit 4, and the control unit 5. Hereinafter, the description overlapping with the description of the filter-plate-type filtration device X1 will be appropriately omitted, and only the characteristics of the filter-plate-type filtration device X3 will be described.

The pressure sealing unit 4 has a pressure seal portion main body 45 formed of an elastic body, and an end portion of the pressure seal portion main body 45 is fixed in the seal flow path (pressing path) 432 of the upper filter plate 2a. Alternatively, the pressure seal portion main body 45 may be made of an elastic material formed into a tube shape.

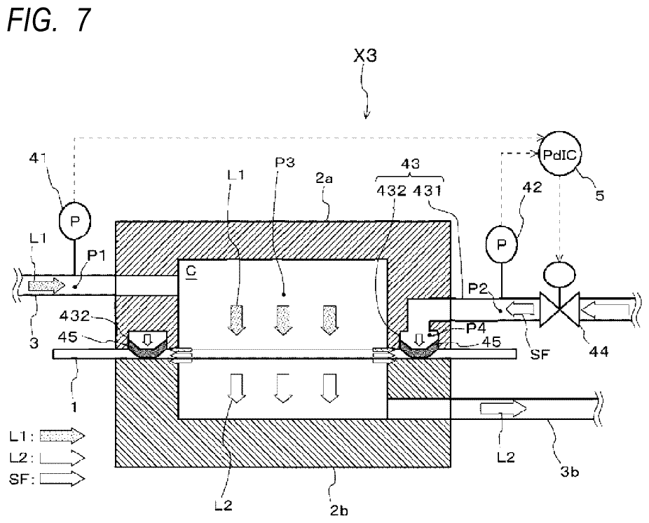

That is, as shown in FIG. 7, the sealing fluid SF supplied from the fluid supply path 43 can bend the elastically deformable pressure seal portion main body 45 downward in the drawing. Therefore, the pressure seal portion main body 45 applies the sealing pressure P4 to a portion in contact with the filter material 1, so that the filter material 1 is crushed and sealed.

That is, the pressure sealing unit 4 can apply the sealing pressure to the filter material 1 by supplying the sealing fluid SF to the pressure seal portion main body 45 to deform the pressure seal portion main body 45.

In the case of the present embodiment, since the sealing fluid SF is not in contact with the raw liquid L1 and the filtrate L2, it is possible to use a liquid such as a pressurized oil in addition to gases such as nitrogen, compressed air, and inert gas as the sealing fluid SF.

Here, the control unit 5 controls the sealing pressure P4 based on the first pressure P1 in the raw liquid introduction path 3 sensed by the first pressure sensing unit 41 and the second pressure P2 in the fluid supply path 43 sensed by the second pressure sensing unit 42.

Specifically, the control unit 5 controls the sealing pressure P4 so as to maintain the differential pressure between the first pressure P1 in the raw liquid introduction path 3 sensed by the first pressure sensing unit 41 and the second pressure P2 in the fluid supply path 43 sensed by the second pressure sensing unit 42 at a predetermined differential pressure value.

In this way, the balance between the filtration chamber pressure P3 estimated from the first pressure P1 in the raw liquid introduction path 3 and the sealing pressure P4 estimated from the second pressure P2 in the fluid supply path 43 is automatically adjusted, and the leakage of the raw liquid and the filtrate from the filtration chamber C can be more effectively and accurately prevented.

The configuration of the third embodiment described above may be combined with the second embodiment to provide the filtration chambers C in multiple stages.

### Fourth Embodiment

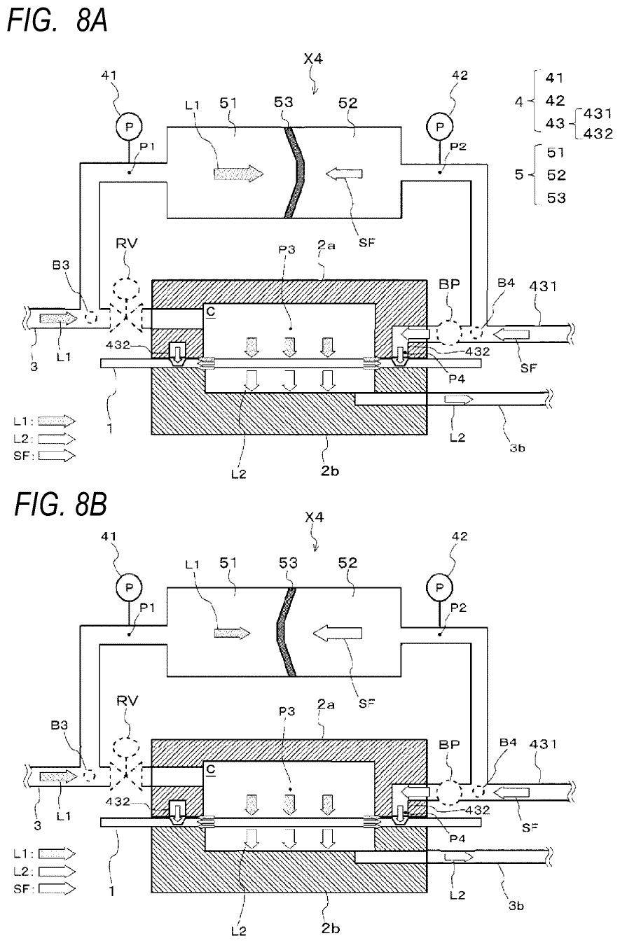

FIGS. 8A and 8B are cross-sectional views of a filter-plate-type filtration device X4 according to another embodiment of the present invention.

As shown in FIGS. 8A and 8B, the filter-plate-type filtration device X4 includes the filter material 1, the plurality of filter plates (upper filter plate 2a and lower filter plate 2b), the filtration chamber C, the raw liquid introduction path 3, the pressure sealing unit 4, and the control unit 5. Hereinafter, the description overlapping with the description of the filter-plate-type filtration device X1 will be appropriately omitted, and only the characteristics of the filter-plate-type filtration device X4 will be described.

The control unit 5 includes a raw liquid chamber 51 communicating with the raw liquid introduction path 3, a fluid chamber 52 communicating with the fluid supply path 43, and a pressure transmission unit 53. The raw liquid chamber 51 and the fluid chamber 52 are coupled to each other while being separated from each other by the pressure transmission unit 53 formed from an elastic body.

That is, the raw liquid L1 and the sealing fluid SF do not move back and forth or mix between the raw liquid chamber 51 and the fluid chamber 52, but the first pressure P1 in the raw liquid introduction path 3 and the second pressure P2 in the fluid supply path 43 are transmitted to each other.

As shown in FIG. 8A, when the first pressure P1 in the raw liquid introduction path 3, that is, the filtration chamber pressure P3 is larger than the second pressure P2 in the fluid supply path 43, that is, the sealing pressure P4, the pressure transmission unit 53 is deformed toward the fluid chamber 52.

As a result, since a spatial volume on the sealing fluid SF side, including the fluid chamber 52 and the fluid supply path 43, is reduced, if the fluid flow rate is constant, the second pressure P2 in the fluid supply path 43, that is, the sealing pressure P4 increases accordingly.

As shown in FIG. 8B, when the first pressure P1 in the raw liquid introduction path 3, that is, the filtration chamber pressure P3 is smaller than the second pressure P2 in the fluid supply path 43, that is, the sealing pressure P4, the pressure transmission unit 53 is deformed toward the raw liquid chamber 51.

As a result, since the spatial volume on the sealing fluid side, including the fluid chamber 52 and the fluid supply path 43, is enlarged, if the fluid flow rate is constant, the second pressure P2 in the fluid supply path 43, that is, the sealing pressure P4 decreases accordingly.

Therefore, even with the control unit 5 configured as described above, it is possible to automatically control the second pressure P2 in the fluid supply path 43, that is, the sealing pressure P4, based on fluctuations in the first pressure P1 in the raw liquid introduction path 3, that is, the filtration chamber pressure P3.

By providing a pressure reducing valve RV in the raw liquid introduction path 3 communicating with the upper filter plate 2a at a position downstream of the branch point B3, or by providing a pressure increasing pump BP in the fluid supply path 43 communicating with the upper filter plate 2a at a position downstream of the branch point B4, it is possible to generate a constant differential pressure between the filtration chamber pressure P3 and the sealing pressure P4.

The configuration of the fourth embodiment described above may be combined with the second embodiment to provide the filtration chambers C in multiple stages. In this case, the branch point B3 is preferably provided upstream of the branch point B1, and the branch point B4 is preferably provided upstream of the branch point B2.

According to the filter-plate-type filtration devices X1 to X4 of the first to fourth embodiments of the present invention, the control unit 5 automatically controls the sealing pressure P4 (or P4a, P4b, P4c, P4d) in response to fluctuations in the filtration chamber pressure P3 (or P3a, P3b, P3c, P3d) so as to prevent the raw liquid L1 and the filtrate L2 in the filtration chamber C (or C1, C2, C3, C4) from leaking to the outside of the filtration chamber C (or C1, C2, C3, C4). Therefore, leakage of the raw liquid L1 and the filtrate L2 can be more effectively prevented.

According to the filter-plate-type filtration devices X1 to X4 of the first to fourth embodiments of the present invention, the pressure sealing unit 4 applies the sealing pressure P4 (or P4a, P4b, P4c, P4d) to the filter material 1 (or 1a, 1b, 1c, and 1d) by supplying the sealing fluid SF to the filter material 1 (or 1a, 1b, 1c, and 1d). Therefore, the leakage path for the raw liquid L1 or the filtrate L2 in a contact portion between the filter material 1 (or 1a, 1b, 1c, and 1d) and each filter plate, and the leakage path for the filtrate L2 inside the filter material 1 (or 1a, 1b, 1c, and 1d) are sealed by the sealing fluid SF, so that the leakage of the raw liquid L1 and the filtrate L2 can be more effectively prevented.

According to the filter-plate-type filtration devices X1 to X4 of the first to fourth embodiments of the present invention, the pressure sealing unit 4 applies the sealing pressure P4 (or P4a, P4b, P4c, P4d) to the filter material 1 (or 1a, 1b, 1c, and 1d) by supplying the sealing fluid SF to the filter material 1 (or 1a, 1b, 1c, and 1d) from a plurality of different directions. Therefore, the sealing pressure P4 (or P4a, P4b, P4c, P4d) is supplied to the filter material 1 (or 1a, 1b, 1c, and 1d) evenly, and the leakage of the raw liquid L1 and the filtrate L2 can be more effectively prevented.

According to the filter-plate-type filtration devices X1 to X4 of the first to fourth embodiments of the present invention, the control unit 5 automatically controls the sealing pressure P4 (or P4a, P4b, P4c, P4d) so as to prevent the raw liquid L1 and the filtrate L2 from leaking to the outside of the filtration chamber C (or C1, C2, C3, C4). Therefore, not only the leakage of the raw liquid L1 and the filtrate L2 but also oversupply of the sealing fluid SF can be prevented.

According to the filter-plate-type filtration devices X1 to X4 of the first to fourth embodiments of the present invention, the control unit automatically controls the sealing pressure P4 (or P4a, P4b, P4c, P4d) so as to prevent the sealing fluid SF supplied to the filter material 1 (or 1a, 1b, 1c, 1d) from entering the filtration chamber C (or C1, C2, C3, C4). Therefore, not only the leakage of the raw liquid L1 and the filtrate L2, but also deterioration of the filtering accuracy and the filter quality caused by the entry of the sealing fluid SF into the filtration chamber C (or C1, C2, C3, C4) can be prevented.

According to the filter-plate-type filtration devices X1 to X4 of the first to fourth embodiments of the present invention, the control unit 5 controls the sealing pressure P4 (or P4a, P4b, P4c, P4d) so as to maintain the differential pressure between the filtration chamber pressure P3 (or P3a, P3b, P3c, P3d) and the sealing pressure P4 (or P4a, P4b, P4c, P4d) at a predetermined differential pressure value. Therefore, robust control can be performed even against large pressure fluctuations.

According to the filter-plate-type filtration devices X1 to X4 of the first to fourth embodiments of the present invention, the control unit controls the sealing pressure P4 (or P4a, P4b, P4c, P4d) based on the filtration chamber pressure P3 (or P3a, P3b, P3c, P3d) estimated based on the first pressure P1 in the raw liquid introduction path 3. Therefore, there is no need to provide a sensing unit in the filtration chamber C (or C1, C2, C3, C4), and the structure of each filter plate can be simplified.

According to the filter-plate-type filtration devices X1 to X4 of the first to fourth embodiments of the present invention, the control unit controls the sealing pressure P4 (or P4a, P4b, P4c, P4d) based on the filtration chamber pressure P3 (or P3a, P3b, P3c, P3d) estimated based on the first pressure P1 in the raw liquid introduction path 3 sensed by the first pressure sensing unit 41 and the second pressure P2 in the fluid supply path 43 sensed by the second pressure sensing unit 42. Therefore, the first pressure P1 and the second pressure P2 can be used to perform more accurate sealing pressure control, the leakage prevention effect can be further improved.

According to a method using the filter-plate-type filtration devices X1 to X4 according to the first to fourth embodiments of the present invention, in a pressure control step, the sealing pressure P4 (or P4a, P4b, P4c, P4d) is automatically controlled in response to fluctuations in the filtration chamber pressure P3 (or P3a, P3b, P3c, P3d) so as to prevent the raw liquid to be filtrated and the filtrate from leaking to the outside of the filtration chamber C (or C1, C2, C3, C4). Therefore, leakage of the raw liquid L1 and the filtrate L2 can be more effectively prevented.

According to a method using the filter-plate-type filtration devices X1 to X4 according to the first to fourth embodiments of the present invention, in a pressure sealing step, the sealing pressure P4 (or P4a, P4b, P4c, P4d) is supplied to the filter material 1 (or 1a, 1b, 1c, and 1d) by supplying the sealing fluid SF to the filter material 1 (or 1a, 1b, 1c, and 1d). Therefore, the leakage path for the raw liquid L1 or the filtrate L2 in a contact portion between the filter material 1 (or 1a, 1b, 1c, and 1d) and each filter plate, and the leakage path for the filtrate L2 inside the filter material 1 (or 1a, 1b, 1c, and 1d) are sealed by the sealing fluid SF, so that the leakage of the raw liquid L1 and the filtrate L2 can be more effectively prevented.

According to a method using the filter-plate-type filtration devices X1 to X4 according to the first to fourth embodiments of the present invention, in the pressure sealing step, the sealing pressure P4 (or P4a, P4b, P4c, P4d) is supplied to the filter material 1 (or 1a, 1b, c, and 1d) by supplying the sealing fluid SF to the filter material 1 (or 1a, 1b, 1c, and 1d) from a plurality of different directions. Therefore, the sealing pressure P4 (or P4a, P4b, P4c, P4d) is supplied to the filter material 1 (or 1a, 1b, 1c, and 1d) evenly, and the leakage of the raw liquid L1 and the filtrate L2 can be more effectively prevented.

According to a method using the filter-plate-type filtration devices X1 to X4 according to the first to fourth embodiments of the present invention, in a pressure control step, the sealing pressure P4 (or P4a, P4b, P4c, P4d) is automatically controlled so as to prevent the raw liquid to be filtrated L1 and the filtrate L2 from leaking to the outside of the filtration chamber C (or C1, C2, C3, C4). Therefore, not only the leakage of the raw liquid L1 and the filtrate L2 but also oversupply of the sealing fluid SF can be prevented.

According to a method using the filter-plate-type filtration devices X1 to X4 according to the first to fourth embodiments of the present invention, in the pressure control step, the sealing pressure P4 (or P4a, P4b, P4c, P4d) can be automatically controlled so as to prevent the sealing fluid supplied to the filter material 1 (or 1a, 1b, 1c, 1d) from entering the filtration chamber C (or C1, C2, C3, C4). Therefore, not only the leakage of the raw liquid L1 and the filtrate L2, but also deterioration of the filtering accuracy and the filter quality caused by the entry of the sealing fluid SF into the filtration chamber C (or C1, C2, C3, C4) can be prevented.

According to the filter-plate-type filtration device X2 of the second embodiment of the present invention, the first pressure sensing unit 41 senses the first pressure P1 in the raw liquid introduction path 3 upstream of the branch point B1 of the branch introduction paths 31a, 31b, 31c and 31d. Therefore, by providing a plurality of filtration chambers, the processing capacity of the device can be improved, while the number of necessary sensing units can be reduced, simplifying the configuration.

According to the filter-plate-type filtration device X2 of the second embodiment of the present invention, the second pressure sensing unit 42 senses the second pressure P2 in the fluid supply path upstream of the branch point B2 of the branch supply paths 431a, 431b, 431c and 431d. Therefore, by providing a plurality of filtration chambers, the processing capacity of the device can be improved, while the number of necessary sensing units can be reduced, simplifying the configuration.

Further, by controlling the sealing pressures P4a, P4b, P4c, and P4d based on the first pressure P1 in the raw liquid introduction path 3 upstream of the branch point B1 of the branch introduction paths 31a, 31b, 31c and 31d and the second pressure P2 in the fluid supply path 43 upstream of the branch point B2 of the branch supply paths 431a, 431b, 431c and 431d, it is possible to minimize the leakage of the raw liquid L1 and the filtrate L2 that may occur in each filtration chamber and the oversupply of the sealing fluid SF in the entire filter.

According to the filter-plate-type filtration device X2 of the second embodiment of the present invention, the control unit controls the sealing pressures P4a, P4b, P4c and P4d so as to maintain the differential pressure between the first pressure P1 in the raw liquid introduction path 3 and the second pressure P2 in the fluid supply path 43 at a predetermined differential pressure value. Therefore, it is possible to perform robust sealing pressure control so as to minimize the leakage of the raw liquid L1 and the filtrate L2 that may occur in each filtration chamber and the oversupply of the sealing fluid SF.

According to the filter-plate-type filtration device X3 of the third embodiment of the present invention, the pressure sealing unit 4 includes the pressure seal portion main body 45 formed of an elastic body, and applies the sealing pressure P4 to the filter material 1 by supplying the sealing fluid SF to deform the pressure seal portion main body 45. Therefore, the sealing fluid SF is not in contact with the raw liquid L1 and the filtrate L2, and a liquid such as a pressurized oil in addition to gases such as nitrogen, compressed air, and inert gas can be used as the sealing fluid SF.

According to a method using the filter-plate-type filtration device X3 according to the third embodiment of the present invention, the sealing pressure P4 is supplied to the filter material 1 by supplying the sealing fluid SF to deform the elastic body. Therefore, the sealing fluid SF is not in contact with the raw liquid L1 and the filtrate L2, and a liquid such as a pressurized oil in addition to gases such as nitrogen, compressed air, and inert gas can be used as the sealing fluid SF.

Although the first to fourth embodiments of the present invention have been described above, the configurations and functions described in the above embodiments are merely examples and may be modified in various ways based on design requirements or the like.

### REFERENCE SIGNS LIST

1, 1a, 1b, 1c, 1d filter material
2a upper filter plate
2b-1, 2b-2, 2b-3 intermediate filter plate
2b lower filter plate
3 raw liquid introduction path
31a, 31b, 31c, 31d branch introduction path
4 pressure sealing unit
41 first pressure sensing unit
42 second pressure sensing unit
43 fluid supply path
431a, 431b, 431c, 431d branch supply path
44 pressure adjusting unit
5 control unit
9 horizontal filter-plate-type filtration device
C, C1, C2, C3, C4 filtration chamber

1. A filter-plate-type filtration device that performs filtration inside a filtration chamber, the filtration chamber being formed by pressing a plurality of filter plates that are freely opened and closed against each other closely with a filter material sandwiched therebetween, the filter-plate-type filtration device comprising:
a plurality of filter plates arranged to sandwich the filter material;
a filtration chamber formed between the filter plates;
a raw liquid introduction path configured to allow a raw liquid to be filtrated to be introduced to the filtration chamber;
a pressure sealing unit configured to apply a sealing pressure to the filter material, by supplying a sealing fluid to the filter material, to prevent leakage of the raw liquid to be filtrated and a filtrate from inside of the filtration chamber to outside of the filtration chamber; and
a control unit configured to automatically control the sealing pressure in response to fluctuations in a filtration chamber pressure.

2. (canceled)

3. The filter-plate-type filtration device according to claim 1, wherein the pressure sealing unit is configured to apply the sealing pressure to the filter material by supplying the sealing fluid to the filter material from a plurality of different directions.

4. A filter-plate-type filtration device that performs filtration inside a filtration chamber, the filtration chamber being formed by pressing a plurality of filter plates that are freely opened and closed against each other closely with a filter material sandwiched therebetween, the filter-plate-type filtration device comprising:
a plurality of filter plates arranged to sandwich the filter material;
a filtration chamber formed between the filter plates;
a raw liquid introduction path configured to allow a raw liquid to be filtrated to be introduced to the filtration chamber;
a pressure sealing unit configured to apply a sealing pressure to the filter material to prevent leakage of the raw liquid to be filtrated and a filtrate from inside of the filtration chamber to outside of the filtration chamber; and
a control unit configured to automatically control the sealing pressure in response to fluctuations in a filtration chamber pressure,
wherein the pressure sealing unit has a pressure seal portion main body formed of an elastic body, and
wherein the pressure sealing unit is configured to apply the sealing pressure to the filter material by supplying a sealing fluid to elastically deform the pressure seal portion main body.

5. The filter-plate-type filtration device according to claim 1, wherein the control unit is configured to automatically control the sealing pressure such that leakage of the raw liquid to be filtrated and the filtrate to the outside of the filtration chamber is prevented.

6. The filter-plate-type filtration device according to claim 1, wherein the control unit is configured to automatically control the sealing pressure such that the sealing fluid supplied to the filter material is prevented from entering the filtration chamber.

7. The filter-plate-type filtration device according to claim 1, wherein the control unit is configured to control the sealing pressure such that a differential pressure between the filtration chamber pressure and the sealing pressure is maintained at a predetermined differential pressure value.

8. The filter-plate-type filtration device according to claim 1,
wherein the pressure sealing unit includes a first pressure sensing unit configured to sense a first pressure in the raw liquid introduction path, and
wherein the control unit is configured to control the sealing pressure based on a filtration chamber pressure estimated from the first pressure in the raw liquid introduction path.

9. The filter-plate-type filtration device according to claim 8,
wherein the pressure sealing unit includes a fluid supply path configured to supply a sealing fluid to the filter material, and a second pressure sensing unit configured to sense a second pressure in the fluid supply path, and
wherein the control unit is configured to control the sealing pressure based on the filtration chamber pressure estimated from the first pressure in the raw liquid introduction path sensed by the first pressure sensing unit and the second pressure in the fluid supply path sensed by the second pressure sensing unit.

10. The filter-plate-type filtration device according to claim 8, further comprising:
a plurality of the filtration chambers,
wherein the raw liquid introduction path has branch introduction paths configured to allow the raw liquid to be filtrated to be introduced to the plurality of filtration chambers, respectively,
wherein the first pressure sensing unit is configured to sense a first pressure in the raw liquid introduction path upstream of a branch point of the branch introduction paths, and
wherein the control unit is configured to control the sealing pressure based on a filtration chamber pressure estimated based on the first pressure in the raw liquid introduction path.

11. The filter-plate-type filtration device according to claim 10,
wherein the pressure sealing unit includes a fluid supply path configured to supply a sealing fluid to the filter material, and a second pressure sensing unit configured to sense a second pressure in the fluid supply path,
wherein the fluid supply path includes branch supply paths configured to supply the sealing fluid to a plurality of the filter material disposed in the plurality of filtration chambers respectively,
wherein the second pressure sensing unit is configured to sense a second pressure in the fluid supply path upstream of a branch point of the branch supply paths, and
wherein the control unit is configured to control the sealing pressure based on the first pressure in the raw liquid introduction path and the second pressure in the fluid supply path.

12. The filter-plate-type filtration device according to claim 9, wherein the control unit is configured to control the sealing pressure such that a differential pressure between the first pressure in the raw liquid introduction path and the second pressure in the fluid supply path is maintained at a predetermined differential pressure value.

13. A filtration method performed by using a filter-plate-type filtration device including a plurality of filter plates arranged with a filter material sandwiched therebetween and a filtration chamber formed between the filter plates, the filtration method comprising:
a pressure sealing step of applying a sealing pressure to the filter material by supplying a sealing fluid to the filter material; and
a pressure control step of automatically controlling the sealing pressure such that leakage of a raw liquid to be filtrated and a filtrate from inside of the filtration chamber to outside of the filtration chamber is prevented.

14. (canceled)

15. The filtration method according to claim 14, wherein in the pressure sealing step, the sealing pressure is supplied to the filter material by supplying the sealing fluid to the filter material from a plurality of different directions.

16. A filtration method performed by using a filter-plate-type filtration device including a plurality of filter plates arranged with a filter material sandwiched therebetween and a filtration chamber formed between the filter plates, the filtration method comprising:
a pressure sealing step of applying a sealing pressure to the filter material by supplying a sealing fluid to the filter material; and
a pressure control step of automatically controlling the sealing pressure such that leakage of a raw liquid to be filtrated and a filtrate from inside of the filtration chamber to outside of the filtration chamber is prevented,
wherein in the pressure sealing step, the sealing pressure is supplied to the filter material by supplying a sealing fluid to elastically deform an elastic body.

17. The filtration method according to claim 13, wherein in the pressure control step, the sealing pressure is automatically controlled such that leakage of the raw liquid to be filtrated and the filtrate to the outside of the filtration chamber is prevented.

18. The filtration method according to claim 13, wherein in the pressure control step, the sealing pressure is automatically controlled such that the sealing fluid supplied to the filter material is prevented from entering the filtration chamber.
